(19) United States
(12) Patent Application Publication
(10) Pub. No.: US 2026/0019896 A1
(43) Pub. Date: Jan. 15, 2026

(54) METHODS AND APPARATUSES FOR ENHANCEMENTS ON SHR

(71) Applicant: LENOVO (BEIJING) LIMITED, Beijing (CN)

(72) Inventors: Le Yan, Shanghai (CN); Mingzeng Dai, Shanghai (CN); Lianhai Wu, Beijing (CN); Congchi Zhang, Shanghai (CN); Yibin Zhuo, Beijing (CN)

(21) Appl. No.: 18/994,558

(22) PCT Filed: Jul. 15, 2022
(86) PCT No.: PCT/CN2022/105975

§ 371 Date: Jan. 14, 2025

(51) Int. Cl. H04W 36/00

(52) U.S. Cl. CPC H04W 36/0079; H04W 36/0072

(57) ABSTRACT

The present application relates to methods and apparatuses for enhancements on a successful handover report (SHR). One embodiment of the present disclosure provides a user equipment (UE), which includes: a transceiver; and a processor coupled with the transceiver and configured to: receive configuration associated with a handover procedure in an unlicensed spectrum, wherein the configuration indicates one or more trigger conditions associated with a successful handover report for the handover procedure that has been successfully completed; and store successful handover related information in the successful handover report in response to fulfillment of at least one of the one or more trigger conditions.

### TECHNICAL FIELD

The present disclosure relates to wireless communication technologies, especially to a method and an apparatus for methods and apparatuses for enhancements on a successful handover report (SHR).

### BACKGROUND OF THE INVENTION

When user equipment (UE) moves among cells, or the radio coverage areas associated with different base stations (BS), the UE needs to perform a handover procedure. In some scenarios, the UE may be triggered to generate an SHR associated with a successful handover, which may include a set of measurements collected during the handover phase, i.e., measurements at the handover trigger, measurements at the end of handover execution, measurements after successful handover execution, or the like, and transmit the SHR to the network, to help the network to further improve the mobility robustness optimization (MRO).

The NR-U feature is introduced in Rel-16, and the UE can operate in the unlicensed spectrum. In an NR-U system, any type of transmission can be transmitted in the unlicensed spectrum. Before transmitting on the unlicensed spectrum, the UE or the BS should perform the listen before talk (LBT) procedure and/or sense the wireless channel, in order to ensure that the wireless channel is not occupied by other transmissions which could be generated by non-3GPP technologies such as WiFi. According to the current trigger conditions for the SHR, some SHRs may be triggered by channel occupancy problems, not mobility issues, and these SHRs should be distinguished such that the network may perform proper actions, e.g. update the relevant configuration.

Accordingly, the present disclosure proposes some solutions for enhancements on an SHR.

### SUMMARY

One embodiment of the present disclosure provides a UE, which includes: a transceiver; and a processor coupled with the transceiver and configured to: receive configuration associated with a handover procedure in an unlicensed spectrum, wherein the configuration indicates one or more trigger conditions associated with a successful handover report for the handover procedure that has been successfully completed; and store successful handover related information in the successful handover report in response to fulfillment of at least one of the one or more trigger conditions.

In some embodiments, the one or more trigger conditions includes at least one of the following: a ratio between a first period of time elapsed since a last handover execution until a successful LBT procedure with a target cell and a configured value of timer T304 being lower than a first threshold; a ratio between a value of elapsed time of one of timer T304, timer T310, or timer T312 and the configured value of the one of timer T304, timer T310, or timer T312 being higher than a second threshold; a ratio between the first period of time and a value of elapsed time of timer T304 being lower than a third threshold; a ratio between a total number of uplink (UL) bandwidth parts (BWP) in the target cell where a consistent LBT failure occurred and a total number of UL BWPs associated with a random access (RA) procedure in the target cell being lower than a fourth threshold; a second period of time elapsed since the last handover execution until a successful LBT procedure with a source cell being lower than a fifth threshold; a ratio between a total number of UL BWPs in the source cell where a consistent LBT failure occurred and a total number of UL BWPs of the source cell being lower than a sixth threshold; or a radio link failure (RLF) in the source cell not due to an LBT failure, wherein the RLF occurred at the source cell during a dual active protocol stack (DAPS) handover procedure while timer T304 is running.

In some embodiments, the successful handover related information includes at least one of the following: an identifier of an UL BWP in a source cell where an LBT procedure is successful; an identifier of an UL BWP in the source cell where LBT fails in the physical (PHY) layer or medium access control (MAC) layer before the LBT procedure is successful; a total number of UL BWPs in the source cell where LBT fails in the PHY layer or MAC layer before the LBT procedure is successful; an identifier of an UL BWP in a target cell where an LBT procedure is successful; an identifier of an UL BWP in the target cell where LBT fails in the PHY layer or MAC layer before the LBT procedure is successful; a total number of UL BWPs in the target cell where LBT fails in the PHY layer or MAC layer before the LBT procedure is successful; a period of time elapsed since a last handover execution until a successful LBT procedure with the target cell; a period of time elapsed since the last handover execution until a successful LBT procedure with the source cell; a period of time elapsed since the last handover execution until UL data transmission with the source cell; a period of time elapsed since the last handover execution until preamble transmission; a period of time elapsed since the last handover execution until MSG3 transmission; a period of time elapsed since the last handover execution until MSGA transmission; a period of time elapsed since the successful LBT procedure with the target cell until the handover procedure has been successfully completed; a period of time elapsed since the successful LBT procedure with the source cell until the handover procedure has been successfully completed; or an indication indicating an RLF in the source cell not due to an LBT failure, wherein the RLF occurred at the source cell during a DAPS handover procedure while timer T304 is running.

In some embodiments, in the case that a first non-duplicated packet from a target cell during a DAPS handover procedure is received earlier than a last packet from a source cell during the DAPS handover procedure, the successful handover related information includes an interruption time with a value of zero, or the successful handover related information does not include the interruption time.

In some embodiments, the interruption time includes at least one of the following: interruption time of each DAPS bearer; interruption time of each non-DAPS bearer; interruption time elapsed from a last packet data convergence protocol (PDCP) protocol data unit (PDU) received from a DAPS bearer or a non-DAPS bearer of the source cell, until a first non-duplicated PDCP PDU received from a DAPS bearer or a non-DAPS bearer of the target cell; maximum interruption time among interruption time of all DAPS bearers; maximum interruption time among interruption time of all non-DAPS bearers; maximum interruption time among interruption time of all DAPS bearers and non-DAPS bearers; minimum interruption time among interruption time of all DAPS bearers; minimum interruption time among interruption time of all non-DAPS bearers; minimum interruption time among interruption time of all DAPS bearers and non-DAPS bearers; average interruption time among interruption time of all DAPS bearers; average interruption time among interruption time of all non-DAPS bearers; or average interruption time among interruption time of all DAPS bearers and non-DAPS bearers.

In some embodiments, the interruption time is measured based on one of the following: the interruption time is measured from a last PDCP PDU received from a DAPS bearer or a non-DAPS bearer of the source cell, until a first non-duplicated PDCP PDU received from a DAPS bearer or a non-DAPS bearer of the target cell; the interruption time is measured per DAPS bearer, for each DAPS bearer, the interruption time is measured from a last PDCP PDU received from the source cell of the DAPS bearer until a first non-duplicated PDCP PDU received from the target cell of the DAPS bearer; or the interruption time is measured per bearer including all DAPS bearers and all non-DAPS bearers, for each bearer, the interruption time is measured from a last PDCP PDU received from the source cell of the bearer until a first non-duplicated PDCP PDU received from the target cell of the bearer.

In some embodiments, the processor is further configured to perform at least one of the following: transmit an indication for indicating storing successful handover related information in the successful handover report; receive a request for the successful handover related information in the successful handover report; or transmit the successful handover report.

Another embodiment of the present disclosure provides a radio access network (RAN) node, which includes: a transceiver; and a processor coupled with the transceiver and configured to: generate configuration associated with a handover procedure in an unlicensed spectrum, wherein the configuration indicates one or more trigger conditions associated with a successful handover report for the handover procedure that has been successfully completed; and transmit the configuration associated with the handover procedure.

In some embodiments, in the case that the RAN node is a target node, and the one or more trigger conditions includes at least one of the following: a ratio between a first period of time elapsed since a last handover execution until a successful LBT procedure with a target cell and a configured value of timer T304 being lower than a first threshold; a ratio between a value of elapsed time of timer T304 and the configured value of timer T304 being higher than a second threshold; a ratio between the first period of time and a value of elapsed time of timer T304 being lower than a third threshold; or a ratio between a total number of UL BWP in the target cell where a consistent LBT failure occurred and a total number of UL BWPs associated with a RA procedure in the target cell being lower than a fourth threshold.

In some embodiments, in the case that the RAN node is a target node, the processor is further configured to: transmit the configuration associated with the handover procedure to a source node.

In some embodiments, in the case that the RAN node is a target node, the processor is further configured to perform at least one of the following: receive a successful handover report from a UE or a third RAN node; or modify configuration associated with LBT based on the successful handover report.

In some embodiments, in the case that the RAN node is a source node, the processor is further configured to: transmit the configuration associated with the handover procedure to a UE.

In some embodiments, in the case that the RAN node is a source node, the processor is further configured to perform at least one of the following: receive a successful handover report from the target RAN node or a third RAN node; or modify configuration associated with LBT based on the successful handover report.

In some embodiments, in the case that the RAN node is a source node, and the one or more trigger conditions includes at least one of the following: a ratio between a value of elapsed time of one of timer T310 or timer T312 and the configured value of the one of timer T310 or timer T312 being higher than a fifth threshold; a second period of time elapsed since the last handover execution until a successful LBT procedure with a source cell being lower than a sixth threshold; a ratio between a total number of UL BWPs in the source cell where a consistent LBT failure occurred and a total number of UL BWPs of the source cell being lower than a seventh threshold; or an RLF in the source cell not due to an LBT failure, wherein the RLF occurred at the source cell during a DAPS handover procedure while timer T304 is running.

In some embodiments, the successful handover related information includes at least one of the following: an identifier of an UL BWP in a source cell where an LBT procedure is successful; an identifier of an UL BWP in the source cell where LBT fails in the PHY layer or MAC layer before the LBT procedure is successful; a total number of UL BWPs in the source cell where LBT fails in the PHY layer or MAC layer before the LBT procedure is successful; an identifier of an UL BWP in a target cell where an LBT procedure is successful; an identifier of an UL BWP in the target cell where LBT fails in the PHY layer or MAC layer before the LBT procedure is successful; a total number of UL BWPs in the target cell where LBT fails in the PHY layer or MAC layer before the LBT procedure is successful; a period of time elapsed since a last handover execution until a successful LBT procedure with the target cell; a period of time elapsed since the last handover execution until a successful LBT procedure with the source cell; a period of time elapsed since the last handover execution until UL data transmission with the source cell; a period of time elapsed since the last handover execution until preamble transmission; a period of time elapsed since the last handover execution until MSG3 transmission; a period of time elapsed since the last handover execution until MSGA transmission; a period of time elapsed since the successful LBT procedure with the target cell until the handover procedure has been successfully completed; a period of time elapsed since the successful LBT procedure with the source cell until the handover procedure has been successfully completed; or an indication indicating an RLF in the source cell not due to an LBT failure, wherein the RLF occurred at the source cell during a DAPS handover procedure while timer T304 is running.

In some embodiments, in the case that a first non-duplicated packet from a target cell during a DAPS handover procedure is received earlier than a last packet from a source cell during the DAPS handover procedure, the successful handover related information includes an interruption time with a value of zero, or the successful handover related information does not include the interruption time.

In some embodiments, the processor is further configured to: maintain current mobility configuration associated with DAPS handover procedure in the case that the interruption time in the successful handover related information has a value of zero, or no interruption time is included in the successful handover related information.

In some embodiments, the interruption time includes at least one of the following: interruption time of each DAPS bearer; interruption time of each non-DAPS bearer; interruption time elapsed from a last PDCP PDU received from a DAPS bearer or a non-DAPS bearer of the source cell, until a first non-duplicated PDCP PDU received from a DAPS bearer or a non-DAPS bearer of the target cell; maximum interruption time among interruption time of all DAPS bearers; maximum interruption time among interruption time of all non-DAPS bearers; maximum interruption time among interruption time of all DAPS bearers and non-DAPS bearers; minimum interruption time among interruption time of all DAPS bearers; minimum interruption time among interruption time of all non-DAPS bearers; minimum interruption time among interruption time of all DAPS bearers and non-DAPS bearers; average interruption time among interruption time of all DAPS bearers; average interruption time among interruption time of all non-DAPS bearers; or average interruption time among interruption time of all DAPS bearers and non-DAPS bearers.

In some embodiments, the interruption time is measured based on one of the following: the interruption time is measured from a last PDCP PDU received from a DAPS bearer or a non-DAPS bearer of the source cell, until a first non-duplicated PDCP PDU received from a DAPS bearer or a non-DAPS bearer of the target cell; the interruption time is measured per DAPS bearer, for each DAPS bearer, the interruption time is measured from a last PDCP PDU received from the source cell of the DAPS bearer until a first non-duplicated PDCP PDU received from the target cell of the DAPS bearer; or the interruption time is measured per bearer including all DAPS bearers and all non-DAPS bearers, for each bearer, the interruption time is measured from a last PDCP PDU received from the source cell of the bearer until a first non-duplicated PDCP PDU received from the target cell of the bearer.

Yet another embodiment of the present disclosure provides a method performed by a UE, which includes: receiving configuration associated with a handover procedure in an unlicensed spectrum, wherein the configuration indicates one or more trigger conditions associated with the handover report for the handover procedure that has been successfully completed; and storing successful handover related information in the successful handover report in response to fulfillment of at least one of the one or more trigger conditions.

Still another embodiment of the present disclosure provides a RAN node, which includes: generating configuration associated with a handover procedure in an unlicensed spectrum, wherein the configuration indicates one or more trigger conditions associated with a successful handover report for the handover procedure that has been successfully completed; and transmitting the configuration associated with the handover procedure.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system according to some embodiments of the present disclosure.

FIG. 2 illustrates a flow chart of a handover procedure according to some embodiments of the present disclosure.

FIG. 3 illustrates a method performed by a UE for enhancements on an SHR according to some embodiments of the present disclosure.

FIG. 4 illustrates a method performed by a RAN node for enhancements on an SHR according to some embodiments of the present disclosure.

FIG. 5 illustrates a simplified block diagram of an exemplary apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

FIG. 1 depicts a wireless communication system according to an embodiment of the present disclosure.

As shown in FIG. 1, the wireless communication system includes UE 101, BS 102-A, and base station 102-B. Even though a specific number of UE and BSs are depicted in FIG. 1, person skilled in the art will recognize that any number of UEs and BSs may be included in the wireless communication system.

The UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, modems), or the like. According to an embodiment of the present disclosure, the UE 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE 101 includes wearable devices, such as smart watches, fitness bands, optical head-mounted displays, or the like. Moreover, the UE 101 may be referred to as subscriber units, mobiles, mobile stations, users, terminals, mobile terminals, wireless terminals, fixed terminals, subscriber stations, UE 101, user terminals, a device, or by other terminology used in the art. The UE 101 may communicate directly with a BS via uplink (UL) communication signals.

The BSs may be distributed over a geographic region. In certain embodiments, a BS may also be referred to as an access point, an access terminal, a base, a base station, a macro cell, a Node-B, a 5G Node-B (gNB), an E-UTRAN Node B (eNB), a BS, a Home Node-B, a relay node, a device, or by any other terminology used in the art. The BSs are generally part of a radio access network that may include one or more controllers communicably coupled to one or more corresponding BSs.

The wireless communication system is compliant with any type of network that is capable of sending and receiving wireless communication signals. For example, the wireless communication system is compliant with a wireless communication network, a cellular telephone network, a time division multiple access (TDMA)-based network, a code division multiple access (CDMA)-based network, an orthogonal frequency division multiple access (OFDMA)-based network, a LTE network, a 3^{rd} generation partnership project (3GPP)-based network, 3GPP 5G network, a satellite communications network, a high altitude platform network, and/or other communications networks. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

In one implementation, the wireless communication system is compliant with the NR of the 3GPP protocol, wherein the BS transmits using an orthogonal frequency division multiplexing (OFDM) modulation scheme on the DL and the UE 101 transmits on the uplink using a single-carrier frequency division multiple access (SC-FDMA) scheme or OFDM scheme. More generally, however, the wireless communication system may implement some other open or proprietary communication protocol, for example, WiMAX, among other protocols.

In other embodiments, the BS may communicate using other communication protocols, such as the IEEE 802.11 family of wireless communication protocols. Further, in some embodiments the BS may communicate over licensed spectrum, while in other embodiments the BS may communicate over unlicensed spectrum. The present disclosure is not intended to be limited to the implementation of any particular wireless communication system architecture or protocol. In another embodiment, the BS may communicate with UE 101 using the 3GPP 5G protocols.

As shown in FIG. 1, the UE 101 is currently served by BS 102-A, and is moving towards BS 102-B. UE 101, BS 102-A, and BS 102-B may operation in the licensed spectrum or in the unlicensed spectrum. In this scenario, the UE may need to perform a handover procedure from BS 102-A to BS 102-B. The BS 102-A is considered as the source node, the source RAN node, the source BS, the source gNB, the source eNB, or the like. The BS 102-B is considered as the target node, the target RAN node, the target BS, the target gNB, the target eNB, etc.

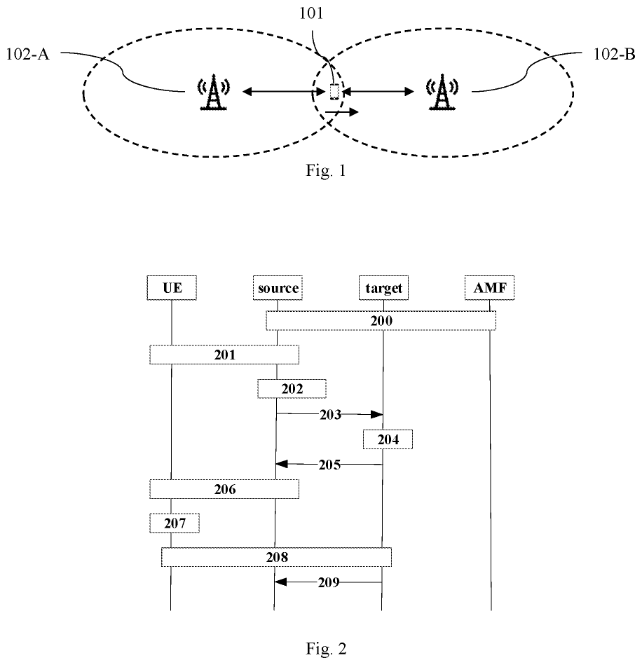

FIG. 2 illustrates a flow chart of a handover procedure according to some embodiments of the present disclosure.

FIG. 2 includes the UE, the source RAN node (which is denoted as “source” in FIG. 2, e.g., the BS 102-A in FIG. 1), the target RAN node (which is denoted as “target” in FIG. 2, e.g., the BS 102-B in FIG. 1), and the access and mobility management function (AMF).

In step 200, the mobility control information is provided by the AMF, i.e. the UE context within the source RAN node contains information regarding roaming and access restrictions which are provided either at connection establishment or at the last tracking area (TA) update.

In step 201, the source RAN node configures the UE measurement procedures, such as transmits configuration associated with a handover procedure to the UE, and then the UE reports according to the configured measurement procedures.

In step 202, the source RAN node decides to hand over the UE, based on measurement report from the UE and radio resource management (RRM) information.

In step 203, the source RAN node transmits a handover request message to the target RAN node, and the source RAN node also transmits a transparent RRC container with necessary information to prepare the handover at the target side.

In step 204, the target RAN node performs admission control. Slice-aware admission control can be performed if the slice information is sent to the target RAN node. If the protocol data unit (PDU) sessions are associated with non-supported slices, the target RAN node may reject such PDU sessions.

In step 205, the target RAN node prepares the handover, and sends the handover request acknowledge to the source RAN node, which includes a transparent container to be sent to the UE as an RRC message to perform the handover. The target RAN node also indicates whether a DAPS handover is accepted.

In step 206, the source RAN node triggers the Uu handover by sending an RRCReconfiguration message to the UE, containing the information required to access the target cell.

In step 207, the UE detaches from the source cell, and is synchronized with the target cell.

In step 208, the UE is synchronized with the target cell and completes the RRC handover procedure by sending a message named as “RRCReconfigurationComplete” to target RAN node. In the case that the handover procedure is a DAPS handover, the UE does not detach from the source cell upon receiving the “RRCReconfiguration” message. The UE releases the source signaling radio bearer (SRB) resources, security configuration of the source cell and stops downlink or uplink reception or transmission with the source RAN node upon receiving an explicit release from the target RAN node.

In step 209, in the case of a DAPS handover, the target RAN node sends the HANDOVER SUCCESS message to the source RAN node to inform that the UE has successfully accessed the target cell.

A DAPS handover can be used for a radio link control (RLC) acknowledged mode (AM) or RLC unacknowledged mode (RLC-UM) bearer. For a DRB configured with DAPS, the following principles are additionally applied.

Regarding the downlink transmission:
Upon allocation of downlink PDCP SNs by the source RAN node, the source RAN node starts scheduling downlink data on the source radio link and also starts forwarding downlink PDCP SDUs along with assigned PDCP SNs to the target RAN node.
For security synchronization, a hyper frame number (HFN) is maintained for the forwarded downlink SDUs with PDCP SNs assigned by the source gNB. The source RAN node sends the EARLY STATUS TRANSFER message to convey the DL COUNT value, indicating the PDCP SN and HFN of the first PDCP SDU that the source gNB forwards to the target RAN node.
The HFN and also PDCP SN are maintained after the SN assignment is handed over to the target gNB. The SN STATUS TRANSFER message indicates the next DL PDCP SN to allocate to a packet which does not have a PDCP sequence number yet, even for RLC-UM.
During the handover execution period, the UE continues to receive downlink data from both source and target RAN nodes until the source RAN node connection is released by an explicit release command from the target gNB.

The motivation for the DAPS handover procedure is to reduce the user plane (UP) interruption during a handover procedure, i.e. to achieve Oms UP interruption time during handover procedure. To enable the network to know whether the DAPS handover related parameters are set properly, the actual user plane interruption time during a DAPS handover procedure is introduced in an SHR for a DAPS handover procedure.

In a DAPS handover procedure, early data forwarding is performed, i.e., the source node forwards downlink PDCP service data unit (SDU) s along with assigned PDCP sequence numbers (SNs) to the target node, upon the successful handover to the target node, the target node can transmit DL packets (which may include duplicated DL PDCP PDUs (i.e., the corresponding DL PDCP SDUs are received from the source node, and the target node performs PDCP handling, e.g. header compression, integrity protection, or ciphering, for the received DL PDCP SDUs), non-duplicated DL PDCP PDUs, or both) to the UE. The UE receives downlink data from both the source node and the target node until the source node connection is released by an explicit release command from the target node.

For a DAPS handover procedure in a licensed or unlicensed system, the interruption time is started to be measured at the time upon the time of arrival of the last PDCP PDU received from the source cell (denoted as T_{source} for clarity), and ended at the time upon the time of arrival of the first non-duplicated PDCP PDU received from the target cell (denoted as T_{target} for clarity). The value of the interruption time may be calculated by (T_{target}−T_{source}). However, there are cases that the UE receives the first non-duplicated packet from the target cell earlier than a last packet from the source cell, that is, T_{target} is earlier than T_{source}. Based on the storing or logging principle for the interruption time, the interruption time included in the SHR would be lower than zero, which is not a valid value. The network may not understand the meaning of the invalid value. The present disclosure proposes some solutions for solving this issue:

### Solution 1

Solution 1 may be applied to systems including both the unlicensed NR-U system and the NR licensed system.

Solution 1-1: the interruption time is set to be “zero” in the case that T_{target} is earlier than T_{source}.

In the case that the UE detects that the first non-duplicated packet from the target cell (i.e., T_{target}) is received earlier than the last packet from the source cell (i.e., T_{source}), the UE may set or store (or log, record, etc., hereinafter “store,” “record,” or “log” may be used interchangeably where appropriate) the interruption time in the SHR to be “zero”. At the network side, since the interruption time included in the SHR is “zero”, the network (for example, the target node, the source node, etc.) understands that the goal of the Oms UP interruption time is achieved in this DAPS handover procedure, and there is no need to modify DAPS handover related mobility parameters. In other words, the network may maintain the current DAPS handover related mobility parameters after MRO analysis based on the SHR.

In this solution, the interruption time included in the SHR may be zero or higher than zero, and the network can understand the meaning of the value of the interruption time, and the problem is solved.

Solution 1-2: the interruption time is not stored in the SHR in the case that T_{target} is earlier than T_{source}. Or, the interruption time is included in the SHR only when a last PDCP PDU received from the source cell of a DAPS handover was earlier than a first non-duplicated PDCP PDU received from the target cell of the DAPS handover.

In the case that the UE detects that the first non-duplicated packet from the target cell (i.e., T_{target}) is received earlier than the last packet from the source cell (i.e., T_{source}), the UE does not store the interruption time in the SHR. That is, in the case that the UE receives the last packet from the source cell (i.e., T_{source}) later than the first non-duplicated packet from the target cell (i.e., T_{target}), the UE may not include the interruption time in the SHR.

As for the case that the UE receives the last packet from the source cell (i.e., T_{source}) and the first non-duplicated packet from the target cell (i.e., T_{target}) at the same time, i.e., T_{source}=T_{target}, the interruption time may be zero, and UE may include the interruption time with the value of “zero” in the SHR as in solution 1-1. Alternatively, the UE may also not include the interruption time in the SHR.

At the network side, when there is no interruption time in the SHR, the network understands that the goal of the Oms UP interruption time is achieved in this DAPS handover procedure, and there is no need to modify the DAPS handover related mobility parameters. In other words, the network may maintain the current DAPS handover related mobility parameters after MRO analysis based on the SHR.

In this solution, the interruption time included in the SHR may be absent, zero, or may be a value greater than zero, and the network understands the meaning of the above conditions, i.e., the interruption time is absent, zero, or greater than zero, and the problem is solved.

Based on Solution 1, the interruption time in DAPS HO procedure can be properly stored or reported in the SHR. Another issue is what is the granularity of the interruption time; the present disclosure proposes some solutions for solving this issue:

### Solution 2

Solution 2 may be applied to systems including both the unlicensed NR-U system and the NR licensed system. Solution 2 may be applied to the case that a first non-duplicated packet from a target cell during a DAPS handover procedure is received earlier than a last packet from a source cell during the DAPS handover procedure, or the case that a first non-duplicated packet from a target cell during a DAPS handover procedure is received later than a last packet from a source cell during the DAPS handover procedure, or the case that a first non-duplicated packet from a target cell during a DAPS handover procedure is received at the same time as a last packet from a source cell during the DAPS handover procedure is received.

The DAPS handover is configured per DRB to the UE, which means the Oms UP interruption time is required for DAPS DRBs but not required for the remaining ones. However, according to the current calculation of the interruption time, the granularity of the interruption time included in the SHR is not clear.

Solution 2-1: the interruption time is measured per DAPS bearer.

During a DAPS handover, a number of DAPS bearers may be configured, for example, N_{DAPS} DAPS bearers. For each DAPS bearer, the interruption time may be measured from the last PDCP PDU received from the source cell of the DAPS bearer until the first non-duplicated PDCP PDU received from the target cell of the DAPS bearer. The number of values of interruption time stored or reported by the UE may be N_{DAPS}, in other words, there may be N_{DAPS} interruption time values, each interruption time value is measured for one bearer of the N_{DAPS} DAPS bearers. Or, the number of values of interruption time stored or reported by the UE may be one, e.g. the maximum value, the minimum value, or average value of interruption time. The UE may store at least one the following in the SHR:
the interruption time of each DAPS bearer;
the maximum interruption time among the N_{DAPS} interruption time of all DAPS bearers;
the minimum interruption time among the N_{DAPS} interruption time of all DAPS bearers; or
average interruption time among the N_{DAPS} interruption time of all DAPS bearers.

Solution 2-2: the interruption time is measured per bearer.

During a DAPS handover, a number of DAPS bearers and a number of a non-DAPS bearer may be configured as, for example, N_{DAPS} DAPS bearers and N_{non-DAPS} non-DAPS bearers. For each bearer of the N_{DAPS} DAPS bearers and the N_{non-DAPS} non-DAPS bearers, the interruption time may be measured from the last PDCP PDU received from the source cell of the bearer until the first non-duplicated PDCP PDU received from the target cell of the bearer.

The number of values of interruption time stored or reported by the UE may be (N_{DAPS}+N_{non-DAPS}) interruption time in total, in other words, there may be (N_{DAPS}+N_{non-DAPS}) interruption time values, each interruption time value is measured for one bearer of the N_{DAPS} DAPS bearers and N_{non-DAPS} non-DAPS bearers. The UE may store at least one the following in the SHR:
interruption time of each DAPS bearer;
interruption time of each non-DAPS bearer;
the maximum interruption time among interruption time of all DAPS bearers, i.e., the maximum interruption time among the N_{DAPS} interruption time of all DAPS bearers;
the maximum interruption time among interruption time of all non-DAPS bearers, i.e., the maximum interruption time among the N_{non-DAPS} interruption time of all non-DAPS bearers;
the maximum interruption time among interruption time of all DAPS bearers and non-DAPS bearers, i.e., the maximum interruption time among the N_{DAPS} interruption time of all DAPS bearers and the N_{non-DAPS} interruption time of all non-DAPS bearers;
the minimum interruption time among interruption time of all DAPS bearers, i.e., the minimum interruption time among the N_{DAPS} interruption time of all DAPS bearers;
the minimum interruption time among interruption time of all non-DAPS bearers, i.e., the minimum interruption time among the N_{non-DAPS} interruption time of all non-DAPS bearers;
the minimum interruption time among interruption time of all DAPS bearers and non-DAPS bearers, i.e., the minimum interruption time among the N_{DAPS} interruption time of all DAPS bearers and the N_{non-DAPS} interruption time of all non-DAPS bearers;
the average interruption time among interruption time of all DAPS bearers i.e., the average interruption time among the N_{DAPS} interruption time of all DAPS bearers;
the average interruption time among interruption time of all non-DAPS bearers, i.e., the average interruption time among the N_{non-DAPS} interruption time of all non-DAPS bearers; or
the average interruption time among interruption time of all DAPS bearers and non-DAPS bearers, i.e., the average interruption time among the N_{DAPS} interruption time of all DAPS bearers and the N_{non-DAPS} interruption time of all non-DAPS bearers.

Solution 2-3: the interruption time is measured from a last PDCP PDU received from the source cell of a DAPS bearer or a non-DAPS bearer, until a first non-duplicated PDCP PDU received from the target cell of a DAPS bearer or a non-DAPS bearer, then the UE stores the interruption time in the SHR. In this solution, the number of values of interruption time stored or reported by the UE is only one.

In some cases, when both solution 1 and solution 2 are applied, and the first non-duplicated packet from the target cell (i.e., T_{target}) is received earlier than the last packet from the source cell (i.e., T_{source}), that is, the UE may determine the interruption time based on solution 1, that is, the interruption time may be absent, may be zero, or a value larger than zero.

The MRO function in NR could be enhanced to provide more robust mobility via reporting failure events observed during successful handovers from a source next generation-radio access network (NG-RAN) to a target NG-RAN. A solution for enhancing the MRO function is to configure the UE to compile a report associated with a successful handover which includes a set of measurements collected during the handover procedure, i.e., measurements at the handover trigger, measurements at the end of handover execution or measurement after successful handover execution, etc. The UE could be configured with one or more triggering conditions to generate the SHR, hence the SHR may be when at least one triggering condition is met. The triggering conditions may include:
the ratio between the value of the elapsed time of the timer T310 and the configured value of the timer T310 is greater than a threshold, i.e. thresholdPercentageT310;
the ratio between the value of the elapsed time of the timer T312 associated with the measurement object of target cell and the configured value of the timer T312 is greater than a threshold, i.e. thresholdPercentageT312;
the ratio between the value of the elapsed time of the timer T304 and the configured value of the timer T304 is greater than a threshold, i.e. thresholdPercentageT304; or
for a DAPS handover procedure, an RLF occurs in source cell before a successful handover procedure.

In the unlicensed spectrum, before performing any transmission during the normal handover procedure, a DAPS handover procedure, or a CHO handover procedure, both the UE and the BS should perform the LBT procedure and sense the wireless channel in order to ensure that the spectrum is not occupied by other transmissions which may be generated by non-3GPP technologies such as WiFi. Additionally, new types of measurements representing the RSSI and channel occupancy have been introduced to reflect the characteristics of the unlicensed channel.

Regarding the LBT failure detection and recovery procedure, the MAC entity may be configured by RRC with a consistent LBT failure recovery procedure. For UL transmission, consistent LBT failure is detected per UL BWP in the MAC entity by counting LBT failure indications received from the lower layers i.e., PHY layer. For example, the UE may perform LBT in a BWP, if the number of LBT failure indications from the physical layer within the valid time which represented as lbt-FailureDetectionTimer, exceeds the maximum value, which may be represented as: lbt-FailureInstanceMaxCount, then the UE determines that a consistent LBT failure happens in this BWP or in MAC layer. If consistent LBT failure happens in all UL BWPs configured with physical random access channel (PRACH) occasions, the MAC entity may indicate such to the upper layer, i.e., RRC layer that LBT failure occurs.

RRC configures the following parameters in the lbt-FailureRecoveryConfig: lbt-FailureInstanceMaxCount for the consistent LBT failure detection; and lbt-FailureDetectionTimer for the consistent LBT failure detection.

The following UE variable is used for the consistent LBT failure detection procedure:
LBT_COUNTER (per serving cell): counter for LBT failure indication which is initially set to 0.

For each activated serving cell configured with lbt-FailureRecoveryConfig, the MAC entity shall perform the following steps:
1> if LBT failure indication has been received from lower layers:
   2> start or restart the lbt-FailureDetectionTimer;
   2> increment LBT_COUNTER by 1;
   2> if LBT_COUNTER>=lbt-FailureInstanceMaxCount:
      3> trigger consistent LBT failure for the active UL BWP in this Serving Cell;
      3> if this Serving Cell is the SpCell:
         4> if consistent LBT failure has been triggered in all UL BWPs configured with PRACH occasions on same carrier in this Serving Cell:
         5> indicate consistent LBT failure to upper layers
         4> else:
         5> stop any ongoing Random Access procedure in this Serving Cell;
         5> switch the active UL BWP to an UL BWP, on same carrier in this Serving Cell, configured with PRACH occasion and for which consistent LBT failure has not been triggered;
         5> initiate a Random Access Procedure.

As mentioned above, an SHR may be triggered by one or more trigger conditions. In an NR-U system, the SHR may also be applied to a near-failure successful handover, and similar principles may be applied. In case the near-failure successful handover occurs, SHR is triggered and reported to let network detect or analyze radio link problem during the handover procedure, thus for modifying handover related parameters e.g. including a reference signal received power (RSRP) threshold, a reference signal received quality (RSRQ) threshold, a signal to interference plus noise ratio (SINR) threshold for triggering handover.

The present disclosure proposes some solutions for triggering the SHR in an NR-U system. In particular, the present disclosure introduces some new trigger conditions in NR-U to exclude the case that an SHR is triggered due to a channel occupancy problem.

### Solution 3-1:

This solution may apply to a normal handover procedure, a DAPS handover procedure, or a CHO procedure in an NR-U system, wherein at least one of the following trigger conditions for the SHR in NR-U may be configured:

Trigger condition 1: in the case that a ratio (denoted as ratio₁ for clarity) is lower than a threshold (denoted as threshold₁ for clarity), the SHR is triggered. The ratio, i.e., ratio₁, may be determined based on the following two periods of time, P₁ and P₂, which are defined as follows:
P₁: a period of time elapsed since the last handover execution until the time when one of the following events with the target cell happens: a successful LBT procedure, a preamble transmission, MSG3 transmission in a 4-step RA procedure, or MSGA transmission in a 2-step RA procedure; and
P₂: the configured value of the timer T304, i.e. which is included in the RRC reconfiguration message for handover.

The ratio, i.e., ratio₁, may be calculated by the following formula (1):

$${ratio}_{1} = \frac{{P}_{1}}{{P}_{2}} \qquad ( 1 )$$

In conclusion, when ratio₁ is lower than threshold₁, the SHR is triggered. The threshold (i.e. threshold₁) may be represented as: thresholdPercentagelforNR-U, and may be configured by the target node. Trigger condition 1 may be generated by the target node, and may be transmitted from the target node to the source node. For example, the value of threshold₁ for trigger condition 1 may be transmitted in the handover request acknowledge message, e.g. in step 205 as shown in FIG. 2. Then, the source node may send the threshold (i.e. threshold₁) to the UE in the RRC reconfiguration message for handover, e.g. in step 206 as shown in FIG. 2.

Trigger condition 2: in the case that a ratio (denoted as ratio₂ for clarity) is greater than a threshold (denoted as threshold₂ for clarity), the SHR is triggered. The ratio, i.e., ratio₂, may be determined based on the following two periods of time, P₃ and P₄, which are defined as follows:
P₃: the elapsed time of one of the following timers: timer T304, timer T310, or timer T312; and
P₄: the configured value of the same timer as P₃, that is, timer T304, timer T310, or timer T312, i.e. which is included in the RRC reconfiguration message.

The ratio, i.e., ratio₂, may be calculated by the following formula (2):

$${ratio}_{2} = \frac{{P}_{3}}{{P}_{4}} \qquad ( 2 )$$

It should be noted that in formula (2), P₃ and P₄ relate to the same timer, for example, when P₃ relates to the elapsed time of timer T310, and P₄ also relates to the configured value of timer T310. For example, trigger condition 2 may be the ratio between the value of the elapsed time of the timer T310 and the configured value of the timer T310 is greater than threshold₂ i.e. thresholdPercentageT310, or the ratio between the value of the elapsed time of the timer T312 associated with the measurement object of target cell and the configured value of the timer T312 is greater than threshold₂ i.e. thresholdPercentageT312, or the ratio between the value of the elapsed time of the timer T304 and the configured value of the timer T304 is greater than threshold₂ i.e. thresholdPercentageT304.

In conclusion, when ratio₂ is greater than threshold₂, the SHR is triggered. In the case that trigger condition 2 relates to timer T304, trigger condition 2 is generated by the target node and transmitted to the source node, then trigger condition 2 may be transmitted from the source node to the UE. For example, the value of threshold₂ may be transmitted from the target node to the source node, and transmitted from the source node to the UE in the RRCReconfiguration message in step 206 as shown in FIG. 2. In the case that trigger condition 2 relates to timer T310 or timer T312, it may be generated by the source node, and may be transmitted from the source node to the UE, for example, the value of threshold₂ may be transmitted in the RRCReconfiguration message in step 206 as shown in FIG. 2.

Trigger condition 3: in the case that a ratio (denoted as ratio₃ for clarity) is lower than a threshold (denoted as threshold₃ for clarity), the SHR is triggered. The ratio, i.e., ratio₃, may be determined based on the following two periods of time, P₁ and P₅, which are defined as follows:
P₁: the same parameter as in trigger condition 1, which is: a period of time elapsed since the last handover execution until the time when one of the following events happens: a successful LBT procedure, a preamble transmission, MSG3 transmission in a 4-step RA procedure, or MSGA transmission in a 2-step RA procedure; and
P₅: the elapsed time of timer T304.

The ratio, i.e., ratio₃, may be calculated by the following formula (3):

$${ratio}_{3} = \frac{{P}_{1}}{{P}_{5}} \qquad ( 3 )$$

In conclusion, when ratio₃ is lower than threshold₃, the SHR is triggered. The threshold (i.e. threshold₃) be may also represented as: thresholdPercentage2forNR-U, and may be configured by the target node, and may be transmitted from the target node to the source node. For example, the value of threshold₃ for trigger condition 3 may be transmitted in the handover request acknowledge message, e.g. in step 205 as shown in FIG. 2. Then, the source node may send the threshold (i.e. threshold₃) to the UE in the RRC reconfiguration message for handover, e.g. in step 206 as shown in FIG. 2.

When at least one of the above triggering conditions 1-3 is satisfied, the UE may store the following content in the SHR, and the UE may report the SHR to the network (e.g. the target node or a third node where the UE connects to after the successful handover). The SHR may include at least one of the following:
the SHR cause related to the triggering condition;
an identifier of the UL BWP in the target cell where an LBT procedure is successful;
an identifier of an UL BWP (or each UL BWP) in the target cell where LBT fails in PHY layer or MAC layer if any before the LBT procedure is successful. The identifier may be absent in the case that no LBT fails in PHY layer or MAC layer before the LBT procedure is successful, or in the case that the LBT with the target cell on the UL BWP of the target cell for the first RACH attempt is successful;
a total number of UL BWPs in the target cell where LBT fails in PHY layer or MAC layer if any before the LBT procedure is successful. The total number of UL BWPs may be zero or absent in the case that no LBT fails in PHY layer or MAC layer before the LBT procedure is successful, or in the case that the LBT with the target cell on the UL BWP of the target cell for the first RACH attempt is successful;
a period of time elapsed since the last handover execution until a successful LBT procedure with the target cell;
a period of time elapsed since the last handover execution until one of the following events happens: a preamble transmission, MSG3 transmission in a 4-step RA procedure, or MSGA transmission in a 2-step RA procedure;
a period of time elapsed since the successful LBT procedure with the target cell until the handover procedure has been successfully completed; or
a period of time elapsed since the handover procedure has been successfully completed until the UE reporting the SHR.

Trigger condition 4: in the case that a ratio (denoted as ratio₄ for clarity) is lower than a threshold (denoted as threshold₄ for clarity), the SHR is triggered. The ratio, i.e., ratio₄, may be determined based on the following two numbers associated with UL BWPs in the target cell:
N₁: a total number of UL BWPs in the target cell where a consistent LBT failure occurred, e.g. in MAC layer; and
N₂: a total number of UL BWPs in the target cell which are configured with random access channel (RACH) configurations. That is, a total number of UL BWPs where the UE may perform a RACH procedure in the target cell, or a total number of UL BWPs which are configured by the network for handover procedure, e.g., a total number of UL BWPs which are configured with RACH configurations for a RACH procedure in the target cell.

The ratio, ratio₄, may be calculated by the following formula (4):

$${ratio}_{4} = \frac{{N}_{1}}{{N}_{2}} \qquad ( 4 )$$

For example, it is supposed that four UL BWPs in the target cell are configured with RACH configurations. The UE may perform an LBT procedure on an UL BWP before performing a RACH procedure on the UL BWP, and may have detected a consistent LBT failure on two UL BWPs before a successful LBT procedure, then

$${ratio}_{4} = \frac{2}{4} = 0.5 .$$

In conclusion, when ratio₄ is lower than threshold₄, the SHR is triggered. The threshold, i.e., threshold₄, may also be represented as: numberPercentageforNR-U, and may be configured by the target node. The threshold, i.e. threshold₄, may be transmitted from the target node to the source node. Then, the source node may send the threshold₄ to the UE in the RRC reconfiguration message for handover.

When the above triggering condition 4 is satisfied, the UE may store the following content in the SHR, and the UE may report the SHR to the network (e.g. the target node or a third node where the UE connects to after the successful handover). The SHR may include at least one of the following:
the SHR cause related to the triggering condition;
a total number of UL BWPs in the target cell where LBT fails in the PHY layer or MAC layer before the LBT procedure is successful;
an identifier of an UL BWP in the target cell where an LBT procedure is successful;
an identifier of each UL BWP in the target cell where LBT fails in the PHY layer or MAC layer before the LBT procedure is successful;
a period of time elapsed since the last handover execution until a successful LBT procedure with the target cell;
a period of time elapsed since the last handover execution until when one of the following events with the target cell happens: preamble transmission, MSG3 transmission in a 4-step RA procedure, or MSGA transmission in a 2-step RA procedure;
a period of time elapsed since the successful LBT procedure with the target cell until the handover procedure has been successfully completed; or
a period of time elapsed since the handover procedure has been successfully completed until reporting the SHR.

### Solution 3-2

This solution may apply to a DAPS handover procedure, besides above four trigger conditions, i.e. Trigger conditions 1-4, at least one of the following trigger conditions for the SHR for a DAPS handover procedure in NR-U may be configured:

Trigger conditions 1-4 are identical to the above trigger conditions 1-4 in solution 3-1, therefore the details are omitted here.

Trigger condition 5: in the case that a period of time (denoted as P₆ for clarity) elapsed since the last handover execution until a successful LBT procedure with the source cell is lower than a threshold (denoted as threshold₅ for clarity), the SHR is triggered. The threshold, i.e. threshold₅, may be configured by the source node, then; the source node may send the threshold (i.e. threshold₅) to the UE via the RRC reconfiguration message.

When triggering condition 5 is satisfied, the UE may store the following content in the SHR, and the UE may report the SHR to the network (e.g. the target node or a third node where the UE connects to after the successful handover). The SHR may include at least one of the following:
the SHR cause related to the triggering condition;
an identifier of an UL BWP in the source cell where an LBT procedure is successful;
an identifier of each UL BWP in the source cell where LBT fails in PHY layer or MAC layer if any before the LBT procedure with the source cell is successful. The identifier may be absent in the case that no LBT fails in PHY layer or MAC layer before the LBT procedure with the source cell is successful, or in the case that the LBT with the source cell on the first UL BWP is successful;
a total number of UL BWPs in the source cell where LBT fails in the PHY layer or MAC layer if any before the LBT procedure with the source cell is successful. The total number of UL BWPs may be zero or absent in the case that no LBT fails in PHY layer or MAC layer before the LBT procedure with the source cell is successful, or in the case that the LBT with the source cell on the first UL BWP is successful;
an identifier of an UL BWP in the target cell where an LBT procedure is successful;
an identifier of each UL BWP in the target cell where LBT fails in PHY layer or MAC layer if any before the LBT procedure with the target cell is successful. The identifier may be absent in the case that no LBT fails in PHY layer or MAC layer before the LBT procedure is successful, or in the case that the LBT with the target cell on the UL BWP of the target cell for the first RACH attempt is successful;
a total number of UL BWPs in the target cell where LBT fails in the PHY layer or MAC layer if any before the LBT procedure with the target cell is successful. The total number of UL BWPs may be zero or absent in the case that no LBT fails in PHY layer or MAC layer before the LBT procedure is successful, or in the case that the LBT with the target cell on the UL BWP of the target cell for the first RACH attempt is successful;
a period of time elapsed since the last handover execution until the successful LBT procedure with the source cell;
a period of time elapsed since the last handover execution until the successful LBT procedure with the target cell;
a period of time elapsed since the last handover execution until when one of the following events with the target cell happens: preamble transmission, MSG3 transmission in a 4-step RA procedure, or MSGA transmission in a 2-step RA procedure;
a period of time elapsed since the successful LBT procedure with the source cell until the handover procedure has been successfully completed;
a period of time elapsed since the successful LBT procedure with the target cell until the handover procedure has been successfully completed; or
a period of time elapsed since the handover procedure has been successfully completed until reporting the SHR.

Trigger condition 6: in the case that a ratio (denoted as ratio₆ for clarity) is lower than a threshold (denoted as threshold₆ for clarity), the SHR is triggered. The ratio, e.g., ratio₆, may be determined based on the following two numbers associated with UL BWPs in the source cell:
N₃: a total number of UL BWPs in the source cell where a consistent LBT failure occurred, e.g. in MAC layer; and
N₄: a total number of UL BWPs in the source cell, e.g. which are configured with UL resources. That is, the total number of UL BWPs where the UE may perform a RACH procedure in the source cell, or the total number of UL BWPs which are configured by the network for handover procedure, e.g., the total number of UL BWPs which are configured with RACH configurations for a RACH procedure in the source cell, or the total number of UL BWPs where the UE may perform uplink data transmission in the source cell.

The ratio, ratio₆, may be calculated by the following formula (5):

$${ratio}_{6} = \frac{{N}_{3}}{{N}_{4}} \qquad ( 5 )$$

In conclusion, when ratio₆ is lower than threshold₆, the SHR is triggered. The threshold, i.e., threshold₆, may be configured by the source node. Then, the source node may send the threshold₆ to the UE via the RRC reconfiguration message.

When triggering condition 6 is satisfied, the UE may store the following content in the SHR, and the UE may report the SHR to the network (e.g. the target node or a third node where the UE connects to after the successful handover). The SHR may include at least one of the following:
the SHR cause related to the triggering condition;
an identifier of each UL BWP in the source cell where LBT fails in a lower layer, for example, the PHY layer or the MAC layer;
an identifier of an UL BWP in the source cell where an LBT procedure is successful;
a total number of UL BWPs in the source cell where LBT fails in the PHY layer or MAC layer before the LBT procedure with source cell is successful;
an identifier of an UL BWP in the target cell where an LBT procedure is successful;
an identifier of each UL BWP in the target cell where LBT fails in PHY layer or MAC layer if any before the LBT procedure with the target cell is successful. The identifier may be absent in the case that no LBT fails in PHY layer or MAC layer before the LBT procedure is successful, or in the case that the LBT with the target cell on the UL BWP of the target cell for the first RACH attempt is successful;
a total number of UL BWPs in the target cell where LBT fails in the PHY layer or MAC layer if any before the LBT procedure with the target cell is successful. The total number of UL BWPs may be zero or absent in the case that no LBT fails in PHY layer or MAC layer before the LBT procedure is successful, or in the case that the LBT with the target cell on the UL BWP of the target cell for the first RACH attempt is successful;
a period of time elapsed since the last handover execution until a successful LBT procedure with the source cell;
a period of time elapsed since the last handover execution until the successful LBT procedure with the target cell;
a period of time elapsed since the last handover execution until when one of the following events with the target cell happens: preamble transmission, MSG3 transmission in a 4-step RA procedure, or MSGA transmission in a 2-step RA procedure;
a period of time elapsed since the successful LBT procedure with the source cell until the handover procedure has been successfully completed;
a period of time elapsed since the successful LBT procedure with the target cell until the handover procedure has been successfully completed, or
a period of time elapsed since a handover procedure has been successfully completed until reporting the SHR.

Trigger condition 7: an RLF occurred at the source cell during the DAPS handover procedure while timer T304 was running, and the RLF is not due to LBT failure, here the LBT failure may include a consistent LBT failure in RRC layer or in MAC layer.

When triggering condition 7 is met, the UE may store the following content in the SHR, and the UE may report the SHR to the network (e.g. the target node or a third node where the UE connects to after the successful handover). The SHR may include at least one of the following:
the SHR cause related to the triggering condition;
an indication indicating that the cause of RLF in the source cell while timer T304 was running is not due to LBT failure;
an identifier of each UL BWP in the source cell where LBT fails in a lower layer if any, for example, the PHY layer or the MAC layer. The identifier may be absent in the case that no LBT fails in PHY layer or MAC layer before the LBT procedure with the source cell is successful, or in the case that the LBT with the source cell on the first UL BWP is successful;
a total number of UL BWPs in the source cell where LBT fails in the PHY layer or MAC layer if any. The total number of UL BWPs may be zero or absent in the case that no LBT fails in PHY layer or MAC layer before the LBT procedure with the source cell is successful, or in the case that the LBT with the source cell on the first UL BWP is successful;
an identifier of an UL BWP in the target cell where an LBT procedure is successful;
an identifier of each UL BWP in the target cell where LBT fails in PHY layer or MAC layer if any before the LBT procedure with the target cell is successful. The identifier may be absent in the case that no LBT fails in PHY layer or MAC layer before the LBT procedure is successful, or in the case that the LBT with the target cell on the UL BWP of the target cell for the first RACH attempt is successful;
a total number of UL BWPs in the target cell where LBT fails in the PHY layer or MAC layer if any before the LBT procedure with the target cell is successful. The total number of UL BWPs may be zero or absent in the case that no LBT fails in PHY layer or MAC layer before the LBT procedure is successful, or in the case that the LBT with the target cell on the UL BWP of the target cell for the first RACH attempt is successful;
a period of time elapsed since the last handover execution until a RLF in the source cell;
a period of time elapsed since the last handover execution until a successful LBT procedure with the target cell;
a period of time elapsed since the last handover execution until when one of the following events with the target cell happens: preamble transmission, MSG3 transmission in a 4-step RA procedure, or MSGA transmission in a 2-step RA procedure;
a period of time elapsed since the successful LBT procedure with the target cell until the handover procedure has been successfully completed, or
a period of time elapsed since the handover procedure has been successfully completed until reporting the SHR.

The UE may store the above information related with a successful handover in the SHR until the SHR is fetched by the network, or store the information related with a successful handover for 48 hours. In some embodiments, the UE may successfully access the target cell, and stay in the target cell. In some other embodiments, the UE may have successfully accessed the target cell, however, within a short period of time, if RLF occurs in the target cell, the UE then performs a RRC reestablishment procedure, and accesses a third cell. In some other embodiments, the UE may have successfully accessed the target cell, however, within a short period of time, the UE performs another handover procedure, and accesses a third cell.

After handover to the target cell, or access to the third cell, the UE may transmit an indication to the target node, or the third node, indicating that successful handover related information in the successful handover report is available at the UE. For example, the availability of a successful handover report may be indicated by the handover complete message (i.e., RRCReconfigurationComplete), the RRC re-establishment complete message, the RRC setup complete message, or the RRC resume complete message. The target node or the third node may fetch information of a successful handover report via a UE information request/response mechanism. That is, the target node or the third node may transmit a request (e.g. a UE information request message) for the successful handover related information included in the successful handover report. After receiving the request, the UE may transmit the successful handover report, which includes the successful handover related information, via a UE information response message, to the target node or to the third node.

At the third node side, it may transmit the SHR from the UE to the target node (e.g. when the SHR is triggered due to timer T304 related trigger condition is fulfilled), to the source node (e.g. when the SHR is triggered due to timer T310 or timer T312 related trigger condition is fulfilled), or both.

At the target node side, it may receive the SHR from the UE or from the third node. The target node may detect or analyze radio link problem during the handover procedure based on the received SHR. Based on SHR, the target node may update mobility related configurations, e.g. update RACH configurations towards the target cell. Or, the target node may modify the configuration associated with LBT, e.g., the configuration for LBT failure recovery. For example, the target node may modify the timer for consistent uplink LBT failure detection, i.e., lbt-FailureDetectionTimer, and the target node may modify the count number that determines after how many consistent uplink LBT failure events the UE triggers an uplink LBT failure recovery, i.e., lbt-FailureInstanceMaxCount. The target node may also transmit the SHR to the source node.

At the source node side, the source node may receive the SHR or the successful handover related information from the target node, or from the third node. The source node may modify LBT related configurations, e.g., received signal strength indicator (RSSI) or channel occupancy (CO) measurement configuration. The source node may update the configuration for LBT Failure Recovery, e.g., the timer for consistent uplink LBT failure detection, i.e., lbt-FailureDetectionTimer, and the count number that determines after how many consistent uplink LBT failure events the UE triggers an uplink LBT failure recovery, i.e., lbt-FailureInstanceMaxCount. The source node may update mobility related parameters, e.g. modify the RSRP threshold, the RSRQ threshold, or the SINR threshold for the handover procedure based on the received SHR.

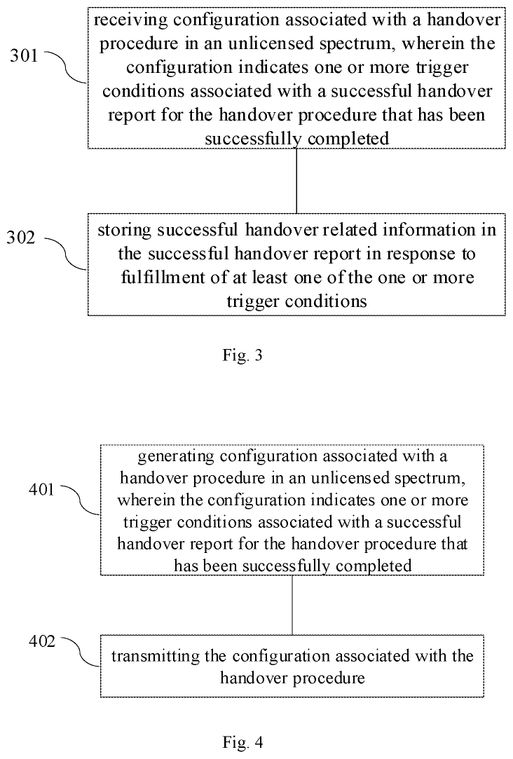

FIG. 3 illustrates a method performed by a UE for enhancements on an SHR according to some embodiments of the present disclosure.

In operation 301, the UE may receive configuration associated with a handover procedure in an unlicensed spectrum, wherein the configuration indicates one or more trigger conditions associated with a successful handover report for the handover procedure that has been successfully completed. In operation 302, store successful handover related information in the successful handover report in response to fulfillment of at least one of the one or more trigger conditions.

In some embodiments, the one or more trigger conditions includes at least one of the following:
a ratio between a first period of time elapsed since a last handover execution until a successful LBT procedure with a target cell and a configured value of timer T304 being lower than a first threshold. For example, the ratio may include ratio₁ in trigger condition 1 as described in solution 3-1.
a ratio between a value of elapsed time of one of timer T304, timer T310, or timer T312 and the configured value of the one of timer T304, timer T310, or timer T312 being higher than a second threshold. For example, the ratio may include ratio₂ in trigger condition 2 as described in solution 3-1.
a ratio between the first period of time and a value of elapsed time of timer T304 being lower than a third threshold. For example, the ratio may include ratio₃ in trigger condition 3 as described in solution 3-1.
a ratio between a total number of UL BWPs in the target cell where a consistent LBT failure occurred and a total number of UL BWPs associated with a RA procedure in the target cell being lower than a fourth threshold. For example, the ratio may include ratio₄ in trigger condition 4 as described in solution 3-1.
a second period of time elapsed since the last handover execution until a successful LBT procedure with a source cell being lower than a fifth threshold. For example, the period of time in trigger condition 5 as described in solution 3-2.
a ratio between a total number of UL BWPs in the source cell where a consistent LBT failure occurred and a total number of UL BWPs of the source cell being lower than a sixth threshold. For example, the ratio may include ratio₆ in trigger condition 6 as described in solution 3-2.
an RLF in the source cell not due to an LBT failure, wherein the RLF occurred at the source cell during a DAPS handover procedure while timer T304 is running. For example, trigger condition 7 as described in solution 3-2.

In some embodiments, the successful handover related information includes at least one of the following:
an identifier of an UL BWP in a source cell where an LBT procedure is successful;
an identifier of an UL BWP in the source cell where LBT fails in the PHY layer or MAC layer before the LBT procedure is successful;
a total number of UL BWPs in the source cell where LBT fails in the PHY layer or MAC layer before the LBT procedure is successful;
an identifier of an UL BWP in a target cell where an LBT procedure is successful;
an identifier of an UL BWP in the target cell where LBT fails in the PHY layer or MAC layer before the LBT procedure is successful;
a total number of UL BWPs in the target cell where LBT fails in the PHY layer or MAC layer before the LBT procedure is successful;
a period of time elapsed since a last handover execution until a successful LBT procedure with the target cell;
a period of time elapsed since the last handover execution until a successful LBT procedure with the source cell;
a period of time elapsed since the last handover execution until UL data transmission with the source cell;
a period of time elapsed since the last handover execution until preamble transmission;
a period of time elapsed since the last handover execution until MSG3 transmission;
a period of time elapsed since the last handover execution until MSGA transmission;
a period of time elapsed since the successful LBT procedure with the target cell until the handover procedure has been successfully completed;
a period of time elapsed since the successful LBT procedure with the source cell until the handover procedure has been successfully completed; or
an indication indicating an RLF in the source cell not due to an LBT failure, wherein the RLF occurred at the source cell during a DAPS handover procedure while timer T304 is running.

In some embodiments, in the case that a first non-duplicated packet from a target cell during a DAPS handover procedure is received earlier than a last packet from a source cell during the DAPS handover procedure, the successful handover related information includes an interruption time with a value of zero, or the successful handover related information does not include the interruption time. That is, the SHR may include an interruption time with a value of zero, or does not include the interruption time.

In some embodiments, for example, in the embodiments that a first non-duplicated packet received from a target cell during a DAPS handover procedure is earlier than, or later than, or at the same time as a last packet received from a source cell during the DAPS handover procedure, the interruption time includes at least one of the following:
interruption time of each DAPS bearer;
interruption time of each non-DAPS bearer;
interruption time elapsed from a last PDCP PDU received from a DAPS bearer or a non-DAPS bearer of the source cell, until a first non-duplicated PDCP PDU received from a DAPS bearer or a non-DAPS bearer of the target cell;
maximum interruption time among interruption time of all DAPS bearers;
maximum interruption time among interruption time of all non-DAPS bearers;
maximum interruption time among interruption time of all DAPS bearers and non-DAPS bearers;
minimum interruption time among interruption time of all DAPS bearers;
minimum interruption time among interruption time of all non-DAPS bearers;
minimum interruption time among interruption time of all DAPS bearers and non-DAPS bearers;
average interruption time among interruption time of all DAPS bearers;
average interruption time among interruption time of all non-DAPS bearers; or
average interruption time among interruption time of all DAPS bearers and non-DAPS bearers.

In some embodiments, the interruption time is measured based on one of the following:
the interruption time is measured from a last PDCP PDU received from a DAPS bearer or a non-DAPS bearer of the source cell, until a first non-duplicated PDCP PDU received from a DAPS bearer or a non-DAPS bearer of the target cell;
the interruption time is measured per DAPS bearer, for each DAPS bearer, the interruption time is measured from a last PDCP PDU received from the source cell of the DAPS bearer until a first non-duplicated PDCP PDU received from the target cell of the DAPS bearer; or
the interruption time is measured per bearer including all DAPS bearers and all non-DAPS bearers, for each bearer, the interruption time is measured from a last PDCP PDU received from the source cell of the bearer until a first non-duplicated PDCP PDU received from the target cell of the bearer.

In some embodiments, the processor is further configured to perform at least one of the following: transmit an indication for indicating storing successful handover related information in the successful handover report; receive a request for the successful handover related information in the successful handover report; or transmit the successful handover report.

FIG. 4 illustrates a method performed by a RAN node for enhancements on an SHR according to some embodiments of the present disclosure.

In operation 401, the RAN node may generate configuration associated with a handover procedure in an unlicensed spectrum, wherein the configuration indicates one or more trigger conditions associated with a successful handover report for the handover procedure that has been successfully completed. In operation 402, the RAN node may transmit the configuration associated with the handover procedure.

In some embodiments, in the case that the RAN node is a target node, for example, BS 102-B in FIG. 1, and the one or more trigger conditions includes at least one of the following:
a ratio between a first period of time elapsed since a last handover execution until a successful LBT procedure with a target cell and a configured value of timer T304 being lower than a first threshold;
a ratio between a value of elapsed time of timer T304 and the configured value of timer T304 being higher than a second threshold;
a ratio between the first period of time and a value of elapsed time of timer T304 being lower than a third threshold; or
a ratio between a total number of UL BWPs in the target cell where a consistent LBT failure occurred and a total number of UL BWPs associated with a RA procedure in the target cell being lower than a fourth threshold.

The above trigger conditions may be generated by the target node, and transmitted to the source node.

In some embodiments, the RAN node may be a target node, and the processor is further configured to: transmit the configuration associated with the handover procedure to a source node. For example, the RAN node may transmit the trigger conditions associated with timer T304 to the source node.

In some embodiments, the RAN node may be a target node, and the processor is further configured to perform at least one of the following: receive a successful handover report from a UE or a third RAN node; or modify configuration associated with LBT based on the successful handover report.

In some embodiments, the RAN node may be a source node, for example, BS 102-A in FIG. 1, and the processor is further configured to: transmit the configuration associated with the handover procedure to a UE. For example, the RAN node may transmit the trigger conditions associated with timer T310 or T312 to the UE.

In some embodiments, the RAN node may be a source node, and the processor is further configured to perform at least one of the following: receive a successful handover report from the target RAN node or a third RAN node; or modify configuration associated with LBT based on the successful handover report.

In some embodiments, the RAN node may be a source node and the one or more trigger conditions includes at least one of the following:
a ratio between a value of elapsed time of one of timer T310 or timer T312 and the configured value of the one of timer T310 or timer T312 being higher than a fifth threshold;
a second period of time elapsed since the last handover execution until a successful LBT procedure with a source cell being lower than a sixth threshold;
a ratio between a total number of UL BWPs in the source cell where a consistent LBT failure occurred and a total number of UL BWPs of the source cell being lower than a seventh threshold; or
an RLF in the source cell not due to an LBT failure, wherein the RLF occurred at the source cell during a DAPS handover procedure while timer T304 is running.

In some embodiments, the RAN node may maintain current mobility configuration associated with DAPS handover procedure in the case that the interruption time in the successful handover related information has a value of zero, or no interruption time is included in the successful handover related information.

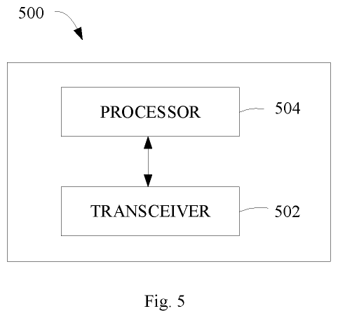

FIG. 5 illustrates a simplified block diagram of an exemplary apparatus according to some embodiments of the present disclosure.

As shown in FIG. 5, an example of the apparatus 500 may include at least one processor 504 and at least one transceiver 502 coupled to the processor 504. The apparatus 500 may be a UE, a BS, a RAN node, a source node, a target node, a third node, or any other device with similar functions.

Although in this figure, elements such as the at least one transceiver 502 and processor 504 are described in the singular, the plural is contemplated unless a limitation to the singular is explicitly stated. In some embodiments of the present disclosure, the transceiver 502 may be divided into two devices, such as a receiving circuitry and a transmitting circuitry. In some embodiments of the present disclosure, the apparatus 500 may further include an input device, a memory, and/or other components.

In some embodiments of the present disclosure, the apparatus 500 may be a UE. The transceiver 502 and the processor 504 may interact with each other so as to perform the operations of the UE described in any of FIGS. 1-4. In some embodiments of the present disclosure, the apparatus 500 may be a node. The transceiver 502 and the processor 504 may interact with each other so as to perform the operations of the node described in any of FIGS. 1-4.

In some embodiments of the present disclosure, the apparatus 500 may further include at least one non-transitory computer-readable medium.

For example, in some embodiments of the present disclosure, the non-transitory computer-readable medium may have stored thereon computer-executable instructions to cause the processor 504 to implement the method with respect to the UE as described above. For example, the computer-executable instructions, when executed, cause the processor 504 interacting with transceiver 502 to perform the operations of the UE described in any of FIGS. 1-4.

In some embodiments of the present disclosure, the non-transitory computer-readable medium may have stored thereon computer-executable instructions to cause the processor 504 to implement the method with respect to the node as described above. For example, the computer-executable instructions, when executed, cause the processor 504 interacting with transceiver 502 to perform the operations of the node described in any of FIGS. 1-4.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each FIG. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE), comprising:
at least one memory; and
at least one processor coupled with the at least one memory and configured to cause the UE to:
receive configuration associated with a handover procedure in an unlicensed spectrum, wherein the configuration indicates one or more trigger conditions associated with a successful handover report for the handover procedure that has been successfully completed; and
store successful handover related information in the successful handover report in response to fulfillment of at least one of the one or more trigger conditions.

2. The UE of claim 1, wherein the one or more trigger conditions includes at least one of the following:
a ratio between a first period of time elapsed since a last handover execution until a successful LBT procedure with a target cell and a configured value of timer T304 being lower than a first threshold;
a ratio between a value of elapsed time of one of timer T304, timer T310, or timer T312 and the configured value of the one of timer T304, timer T310, or timer T312 being higher than a second threshold;
a ratio between the first period of time and a value of elapsed time of timer T304 being lower than a third threshold;
a ratio between a total number of uplink (UL) bandwidth parts (BWP) in the target cell where a consistent LBT failure occurred and a total number of UL BWPs associated with a random access (RA) procedure in the target cell being lower than a fourth threshold;
a second period of time elapsed since the last handover execution until a successful LBT procedure with a source cell being lower than a fifth threshold;
a ratio between a total number of UL BWPs in the source cell where a consistent LBT failure occurred and a total number of UL BWPs of the source cell being lower than a sixth threshold; or
a radio link failure (RLF) in the source cell not due to an LBT failure, wherein the RLF occurred at the source cell during a dual active protocol stack (DAPS) handover procedure while timer T304 is running.

3. The UE of claim 1, wherein the successful handover related information includes at least one of the following:
an identifier of an UL BWP in a source cell where an LBT procedure is successful;
an identifier of an UL BWP in the source cell where LBT fails in physical (PHY) layer or medium access control (MAC) layer before the LBT procedure is successful;
a total number of UL BWPs in the source cell where LBT fails in PHY layer or MAC layer before the LBT procedure is successful;
an identifier of an UL BWP in a target cell where an LBT procedure is successful;
an identifier of an UL BWP in the target cell where LBT fails in PHY layer or MAC layer before the LBT procedure is successful;
a total number of UL BWPs in the target cell where LBT fails in PHY layer or MAC layer before the LBT procedure is successful;
a period of time elapsed since a last handover execution until a successful LBT procedure with the target cell;
a period of time elapsed since the last handover execution until a successful LBT procedure with the source cell;
a period of time elapsed since the last handover execution until UL data transmission with the source cell;
a period of time elapsed since the last handover execution until preamble transmission;
a period of time elapsed since the last handover execution until MSG3 transmission;
a period of time elapsed since the last handover execution until MSGA transmission;
a period of time elapsed since the successful LBT procedure with the target cell until the handover procedure has been successfully completed;
a period of time elapsed since the successful LBT procedure with the source cell until the handover procedure has been successfully completed; or
an indication indicating an RLF in the source cell not due to an LBT failure, wherein the RLF occurred at the source cell during a DAPS handover procedure while timer T304 is running.

4. The UE of claim 1, wherein in the case that a first non-duplicated packet from a target cell during a DAPS handover procedure is received earlier than a last packet from a source cell during the DAPS handover procedure, the successful handover related information includes an interruption time with a value of zero, or the successful handover related information does not include the interruption time.

5. The UE of claim 4, wherein the interruption time includes at least one of the following:
interruption time of each DAPS bearer;
interruption time of each non-DAPS bearer;
interruption time elapsed from a last packet data convergence protocol (PDCP) protocol data unit (PDU) received from a DAPS bearer or a non-DAPS bearer of the source cell, until a first non-duplicated PDCP PDU received from a DAPS bearer or a non-DAPS bearer of the target cell;
maximum interruption time among interruption time of all DAPS bearers;
maximum interruption time among interruption time of all non-DAPS bearers;
maximum interruption time among interruption time of all DAPS bearers and non-DAPS bearers;
minimum interruption time among interruption time of all DAPS bearers;
minimum interruption time among interruption time of all non-DAPS bearers;
minimum interruption time among interruption time of all DAPS bearers and non-DAPS bearers;
average interruption time among interruption time of all DAPS bearers;
average interruption time among interruption time of all non-DAPS bearers; or
average interruption time among interruption time of all DAPS bearers and non-DAPS bearers.

6. The UE of claim 4, wherein the interruption time is measured based on one of the following:
the interruption time is measured from a last PDCP PDU received from a DAPS bearer or a non-DAPS bearer of the source cell, until a first non-duplicated PDCP PDU received from a DAPS bearer or a non-DAPS bearer of the target cell;
the interruption time is measured per DAPS bearer, for each DAPS bearer, the interruption time is measured from a last PDCP PDU received from the source cell of the DAPS bearer until a first non-duplicated PDCP PDU received from the target cell of the DAPS bearer; or
the interruption time is measured per bearer including all DAPS bearers and all non-DAPS bearers, for each bearer, the interruption time is measured from a last PDCP PDU received from the source cell of the bearer until a first non-duplicated PDCP PDU received from the target cell of the bearer.

7. A radio access network (RAN) node, comprising:
at least one memory; and
at least one processor coupled with the at least one memory and configured to cause the RAN node to:
generate configuration associated with a handover procedure in an unlicensed spectrum, wherein the configuration indicates one or more trigger conditions associated with a successful handover report for the handover procedure that has been successfully completed; and
transmit the configuration associated with the handover procedure.

8. The RAN node of claim 7, wherein in the case that the RAN node is a target node, and the one or more trigger conditions includes at least one of the following:
a ratio between a first period of time elapsed since a last handover execution until a successful LBT procedure with a target cell and a configured value of timer T304 being lower than a first threshold;
a ratio between a value of elapsed time of timer T304 and the configured value of timer T304 being higher than a second threshold;
a ratio between the first period of time and a value of elapsed time of timer T304 being lower than a third threshold; or
a ratio between a total number of uplink (UL) bandwidth parts (BWP) in the target cell where a consistent LBT failure occurred and a total number of UL BWPs associated with a random access (RA) procedure in the target cell being lower than a fourth threshold.

9. The RAN node of claim 7, wherein in the case that the RAN node is a target node, the processor is further configured to perform at least one of the following:
receive a successful handover report from a user equipment (UE) or a third RAN node; or
modify configuration associated with LBT based on the successful handover report.

10. The RAN node of claim 7, wherein in the case that the RAN node is a source node, the processor is further configured to perform at least one of the following:
receive a successful handover report from a target RAN node or a third RAN node; or
modify configuration associated with LBT based on the successful handover report.

11. The RAN node of claim 7, wherein in the case that the RAN node is a source node, and the one or more trigger conditions includes at least one of the following:
a ratio between a value of elapsed time of one of timer T310 or timer T312 and a configured value of the one of timer T310 or timer T312 being higher than a fifth threshold;
a second period of time elapsed since the last handover execution until a successful LBT procedure with a source cell being lower than a sixth threshold;
a ratio between a total number of UL BWPs in the source cell where a consistent LBT failure occurred and a total number of UL BWPs of the source cell being lower than a seventh threshold; or
a radio link failure (RLF) in the source cell not due to an LBT failure, wherein the RLF occurred at the source cell during a dual active protocol stack (DAPS) handover procedure while timer T304 is running.

12. The RAN node of claim 7, wherein successful handover related information includes at least one of the following:
an identifier of an UL BWP in a source cell where an LBT procedure is successful;
an identifier of an UL BWP in the source cell where LBT fails in physical (PHY) layer or medium access control (MAC) layer before the LBT procedure is successful;
a total number of UL BWPs in the source cell where LBT fails in PHY layer or MAC layer before the LBT procedure is successful;
an identifier of an UL BWP in a target cell where an LBT procedure is successful;
an identifier of an UL BWP in the target cell where LBT fails in PHY layer or MAC layer before the LBT procedure is successful;
a total number of UL BWPs in the target cell where LBT fails in PHY layer or MAC layer before the LBT procedure is successful;
a period of time elapsed since a last handover execution until a successful LBT procedure with the target cell;
a period of time elapsed since the last handover execution until a successful LBT procedure with the source cell;
a period of time elapsed since the last handover execution until UL data transmission with the source cell;
a period of time elapsed since the last handover execution until preamble transmission;
a period of time elapsed since the last handover execution until MSG3 transmission;
a period of time elapsed since the last handover execution until MSGA transmission;
a period of time elapsed since the successful LBT procedure with the target cell until the handover procedure has been successfully completed;
a period of time elapsed since the successful LBT procedure with the source cell until the handover procedure has been successfully completed; or
an indication indicating an RLF in the source cell not due to an LBT failure, wherein the RLF occurred at the source cell during a DAPS handover procedure while timer T304 is running.

13. The RAN node of claim 7, wherein in the case that a first non-duplicated packet from a target cell during a DAPS handover procedure is received earlier than a last packet from a source cell during the DAPS handover procedure, successful handover related information includes an interruption time with a value of zero, or the successful handover related information does not include the interruption time.

14. The RAN node of claim 13, wherein the interruption time includes at least one of the following:
interruption time of each DAPS bearer;
interruption time of each non-DAPS bearer;
interruption time elapsed from a last packet data convergence protocol (PDCP) protocol data unit (PDU) received from a DAPS bearer or a non-DAPS bearer of the source cell, until a first non-duplicated PDCP PDU received from a DAPS bearer or a non-DAPS bearer of the target cell;
maximum interruption time among interruption time of all DAPS bearers;
maximum interruption time among interruption time of all non-DAPS bearers;
maximum interruption time among interruption time of all DAPS bearers and non-DAPS bearers;
minimum interruption time among interruption time of all DAPS bearers;
minimum interruption time among interruption time of all non-DAPS bearers;
minimum interruption time among interruption time of all DAPS bearers and non-DAPS bearers;
average interruption time among interruption time of all DAPS bearers;
average interruption time among interruption time of all non-DAPS bearers; or
average interruption time among interruption time of all DAPS bearers and non-DAPS bearers.

15. A method performed by a user equipment (UE), the method comprising:
receiving configuration associated with a handover procedure in an unlicensed spectrum, wherein the configuration indicates one or more trigger conditions associated with a handover report for the handover procedure that has been successfully completed; and
storing successful handover related information in a successful handover report in response to fulfillment of at least one of the one or more trigger conditions.

16. A processor for wireless communication, comprising:
at least one controller coupled with at least one memory and configured to cause the processor to:
receive configuration associated with a handover procedure in an unlicensed spectrum, wherein the configuration indicates one or more trigger conditions associated with a successful handover report for the handover procedure that has been successfully completed; and
store successful handover related information in the successful handover report in response to fulfillment of at least one of the one or more trigger conditions.

17. The processor of claim 16, wherein the one or more trigger conditions includes at least one of the following:
a ratio between a first period of time elapsed since a last handover execution until a successful LBT procedure with a target cell and a configured value of timer T304 being lower than a first threshold;
a ratio between a value of elapsed time of one of timer T304, timer T310, or timer T312 and the configured value of the one of timer T304, timer T310, or timer T312 being higher than a second threshold;
a ratio between the first period of time and a value of elapsed time of timer T304 being lower than a third threshold;
a ratio between a total number of uplink (UL) bandwidth parts (BWP) in the target cell where a consistent LBT failure occurred and a total number of UL BWPs associated with a random access (RA) procedure in the target cell being lower than a fourth threshold;
a second period of time elapsed since the last handover execution until a successful LBT procedure with a source cell being lower than a fifth threshold;
a ratio between a total number of UL BWPs in the source cell where a consistent LBT failure occurred and a total number of UL BWPs of the source cell being lower than a sixth threshold; or
a radio link failure (RLF) in the source cell not due to an LBT failure, wherein the RLF occurred at the source cell during a dual active protocol stack (DAPS) handover procedure while timer T304 is running.

18. The processor of claim 16, wherein the successful handover related information includes at least one of the following:
an identifier of an UL BWP in a source cell where an LBT procedure is successful;
an identifier of an UL BWP in the source cell where LBT fails in physical (PHY) layer or medium access control (MAC) layer before the LBT procedure is successful;
a total number of UL BWPs in the source cell where LBT fails in PHY layer or MAC layer before the LBT procedure is successful;
an identifier of an UL BWP in a target cell where an LBT procedure is successful;
an identifier of an UL BWP in the target cell where LBT fails in PHY layer or MAC layer before the LBT procedure is successful;
a total number of UL BWPs in the target cell where LBT fails in PHY layer or MAC layer before the LBT procedure is successful;
a period of time elapsed since a last handover execution until a successful LBT procedure with the target cell;
a period of time elapsed since the last handover execution until a successful LBT procedure with the source cell;
a period of time elapsed since the last handover execution until UL data transmission with the source cell;
a period of time elapsed since the last handover execution until preamble transmission;
a period of time elapsed since the last handover execution until MSG3 transmission;
a period of time elapsed since the last handover execution until MSGA transmission;
a period of time elapsed since the successful LBT procedure with the target cell until the handover procedure has been successfully completed;
a period of time elapsed since the successful LBT procedure with the source cell until the handover procedure has been successfully completed; or
an indication indicating an RLF in the source cell not due to an LBT failure, wherein the RLF occurred at the source cell during a DAPS handover procedure while timer T304 is running.

19. The processor of claim 16, wherein in the case that a first non-duplicated packet from a target cell during a DAPS handover procedure is received earlier than a last packet from a source cell during the DAPS handover procedure, the successful handover related information includes an interruption time with a value of zero, or the successful handover related information does not include the interruption time.

20. The processor of claim 19, wherein the interruption time includes at least one of the following:
interruption time of each DAPS bearer;
interruption time of each non-DAPS bearer;
interruption time elapsed from a last packet data convergence protocol (PDCP) protocol data unit (PDU) received from a DAPS bearer or a non-DAPS bearer of the source cell, until a first non-duplicated PDCP PDU received from a DAPS bearer or a non-DAPS bearer of the target cell;
maximum interruption time among interruption time of all DAPS bearers;
maximum interruption time among interruption time of all non-DAPS bearers;
maximum interruption time among interruption time of all DAPS bearers and non-DAPS bearers;
minimum interruption time among interruption time of all DAPS bearers;
minimum interruption time among interruption time of all non-DAPS bearers;
minimum interruption time among interruption time of all DAPS bearers and non-DAPS bearers;
average interruption time among interruption time of all DAPS bearers;
average interruption time among interruption time of all non-DAPS bearers; or
average interruption time among interruption time of all DAPS bearers and non-DAPS bearers.
